(19) United States
(12) Patent Application Publication
(10) Pub. No.: US 2025/0249733 A1
(43) Pub. Date: Aug. 7, 2025

(54) RETRACTABLE VEHICLE COVER

(71) Applicant: McLaren Automotive Limited, Woking (GB)

(72) Inventors: Robert John Naunton-Evans, Heasley (GB); James Warner, Guilford (GB); Andrew Calvert, Woking (GB)

(21) Appl. No.: 19/044,955

(22) Filed: Feb. 4, 2025

(30) Foreign Application Priority Data
Feb. 7, 2024 (GB) 2401611.5

(51) Int. Cl. B60J 7/02; B60J 7/185; E05F 1/16

(52) U.S. Cl. CPC B60J 7/024; B60J 7/026; B60J 7/185; E05F 1/16; E05Y 2900/542

(57) ABSTRACT

A vehicle having a vehicle floor, a vehicle body and a vehicle cover configured to move between an open position and a closed position, the vehicle body comprising a rail having a first end and a second end, the rail comprising: a flat portion extending along a longitudinal direction of the vehicle at the first end; and a sloped portion inclined towards the vehicle floor at the second end; and the vehicle cover comprising a runner moveable along the rail to permit the vehicle cover to move between the closed position and the open position, wherein the vehicle body further comprises a lifting mechanism that engages with the vehicle cover when the runner is at the second end of the rail, the lifting mechanism being configured to drive the runner along the rail in a direction from the second end towards the first end to permit the vehicle cover to move from the closed position towards the open position.

### TECHNICAL FIELD

This invention relates to a retractable cover for a vehicle.

### BACKGROUND

The design of vehicle doors, particularly doors for road vehicles, has remained fairly consistent for many years. The majority of commercially available road vehicles incorporate doors which attach to the body of the vehicle by hinges and can be opened by pulling the door outwards away from the vehicle body such that it rotates at the hinges about an axis which is substantially perpendicular to the ground. Other road vehicles, for example those designed for racing, can include doors which hinge open by rotating about an axis which is substantially parallel to the ground or about the vehicle's A-pillar.

Larger vehicles which have a height that is greater than that of a passenger, such as vans and trains, commonly incorporate sliding doors on a side wall of the vehicle, the opening of which exposes a cavity in the side wall such that a passenger may enter the vehicle.

It is desirable to develop a vehicle having a sliding door located on the roof of a vehicle, particularly for vehicles which have a height less than that of a passenger, so that a passenger can enter the vehicle from above. The inventors of the present invention have developed a vehicle cover which can slide smoothly open and closed in an aesthetically-pleasing manner and which does not require excessive force from the user to actuate.

### SUMMARY OF THE INVENTION

There is provided a vehicle having a vehicle floor, a vehicle body and a vehicle cover configured to move between an open position and a closed position, the vehicle body comprising a rail having a first end and a second end, the rail comprising a flat portion extending along a longitudinal direction of the vehicle at the first end; and a sloped portion inclined towards the vehicle floor at the second end; and the vehicle cover comprising a runner moveable along the rail to permit the vehicle cover to move between the closed position and the open position, wherein the vehicle body further comprises a lifting mechanism that engages with the vehicle cover when the runner is at the second end of the rail, the lifting mechanism being configured to drive the runner along the rail in a direction from the second end towards the first end to permit the vehicle cover to move from the closed position towards the open position.

The vehicle may comprise a latch mechanism arranged between the vehicle body and the vehicle cover and the lifting mechanism is configured to drive the runner along the rail to move from the closed position towards the open position in response to the latch mechanism being released.

The vehicle cover may comprise a hook configured to engage with the lifting mechanism when the runner is at the second end of the rail.

The lifting mechanism may comprise an arm biased by means of one or more of a spring, a gas strut and a weighted lever.

The arm of the lifting mechanism may be configured to engage the hook when the runner is at the second end of the rail.

The vehicle body and vehicle cover may be arranged such that an external force is required to move the runner along the straight portion of the rail in a direction towards the closed position.

The vehicle may be configured such that when the runner is moving along the straight portion of the rail in a direction towards the closed position and engages the sloped portion of the rail, the runner is configured to sink towards the second end of the rail.

The vehicle body may comprise a vehicle body front and a vehicle body rear and motion of the vehicle cover from the closed position towards the open position may be towards the vehicle front.

The vehicle body may comprise a second rail, the second rail having a first end and a second end, the second rail comprising: a flat portion extending along a longitudinal direction of the vehicle at the first end; and a sloped portion inclined towards the vehicle floor at the second end; and the vehicle cover comprises a second runner moveable along the second rail

The shape of the second rail may be the same as the shape of the first rail.

The vehicle body may comprise a second lifting mechanism that engages with the vehicle cover when the second runner is at the second end of the rail, the second lifting mechanism being configured to drive the second runner along the second rail in a direction from the second end of the second rail towards the first end of the second rail.

The vehicle cover may comprise a second hook configured to engage with the second lifting mechanism when the second runner is at the second end of the second rail.

The vehicle body may comprise a vehicle body front and a vehicle body rear and a longitudinal centre line extending between the vehicle body front and the vehicle body rear and intersecting the vehicle cover.

The rail may be located on a first side of the longitudinal centre line and the second rail may be located on a second side of the longitudinal centre line.

The vehicle body may comprise a third rail located on the first side of the longitudinal centre line and a fourth rail located on the second side of the longitudinal centre line.

The third rail and the fourth rail may each have a first end and a second end and comprise a flat portion extending along a longitudinal direction of the vehicle at the first end; and a sloped portion inclined towards the floor of the vehicle at the second end.

The first end of the third rail may be located between the first rail and the vehicle body front and the first end of the fourth rail may be located between the second rail and the vehicle body front.

The vehicle cover may comprise a third runner moveable along the third rail on the vehicle body and a fourth runner moveable along the fourth rail on the vehicle body.

The lifting mechanism may be further configured to drive the third runner along the third rail in a direction from the second end of the third rail towards the first end of the third rail and the second lifting mechanism my be further configured to drive the fourth runner along the fourth rail in a direction from the second end of the fourth rail towards the first end of the fourth rail.

The sloped portion may be curved.

The sloped portion may be straight and transverse to the flat portion.

The sloped portion may be at a 45 degree angle with respect to the flat portion.

The perpendicular distance between the first end of the rail and the second end of the rail may be 40 mm.

The flat portion may have a length of 500 mm.

### BRIEF DESCRIPTION OF THE DRAWINGS

FIG. 1 illustrates a vehicle having a vehicle cover in a closed position.

FIG. 2 illustrates a vehicle having a vehicle cover in an open position.

FIG. 3 illustrates a vehicle cover and an actuating mechanism.

FIG. 4 illustrates a vehicle cover lifting mechanism.

FIG. 5 illustrates a bird's eye view of a vehicle having a vehicle cover in a closed position.

### DETAILED DESCRIPTION OF THE DRAWINGS

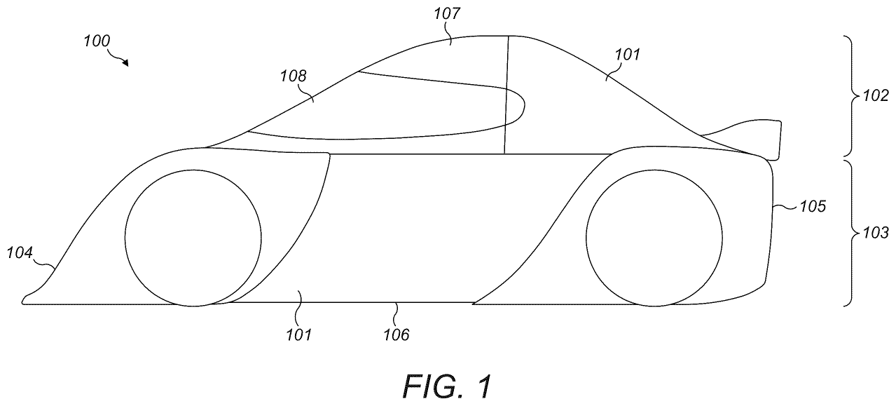

FIG. 1 illustrates a vehicle 100. The vehicle has a vehicle body 101. The vehicle body 101 includes an upper vehicle body 102 and a lower vehicle body 103. The vehicle body 101 includes a vehicle body front 104, a vehicle body rear 105 and a vehicle body floor 106. The vehicle further includes a vehicle cover 107. The vehicle cover 107 includes a windscreen 108. As will be described in more detail below, the vehicle cover 107 can be moved between a closed position and an open position. In other words, the vehicle cover has a range of motion relative to the vehicle body 101 which extends between the open position and the closed position. In FIG. 1, the vehicle cover 107 is in a closed position. In the closed position, the vehicle cover 107 is at its rearmost position relative to the vehicle body 101. In the closed position, the vehicle cover is at the point within the range of motion which is closest to the vehicle body rear 105.

When the vehicle cover 107 is in the closed position, the vehicle cover abuts the upper vehicle body 102. The vehicle cover 107 also abuts the lower vehicle body 103. When the vehicle cover 107 is in the closed position, the vehicle cover 107 and the vehicle body 101 encapsulate a volume within the vehicle 100 in which a driver may sit to operate the vehicle. In other words, the vehicle cover 107 and the vehicle body 101 form a closed cabin within the vehicle.

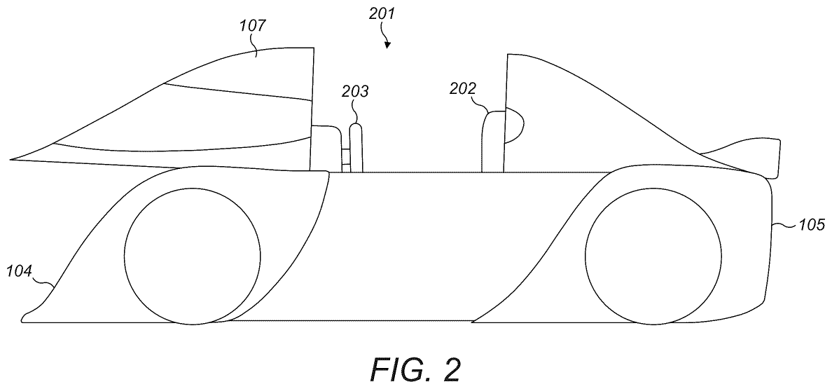

FIG. 2 illustrates cabin 201 of the same vehicle 100 and vehicle cover 107. In order for the driver to enter and exit the vehicle 100, i.e. to gain access to the cabin 201, the vehicle cover 107 can be moved to an open position. In FIG. 2, the vehicle cover 107 is in an open position. In the open position, the cabin 201 is fully exposed to the outside of the vehicle 100. As illustrated in FIG. 2, the cabin 201 may include a driving seat 202 and a steering wheel 203.

In other words, the cabin 201 is accessible to the outside of the vehicle such that a driver may enter or exit the cabin. It will be appreciated that any position of the vehicle cover 107 along its range of motion between the open position and closed position, apart from the closed position, will mean that the cabin 201 is at least partially exposed to the outside of the vehicle 100. However, in the present application, the open position is described as the position of the vehicle cover 107 when the vehicle cover is at its frontmost position relative to the vehicle body 101. In the open position, the vehicle cover is at the point within the range of motion which is closest to the vehicle body front 104. According to some examples, when the vehicle cover 107 is in the open position, the vehicle cover 107 is at least partially located forward of the vehicle body front 104.

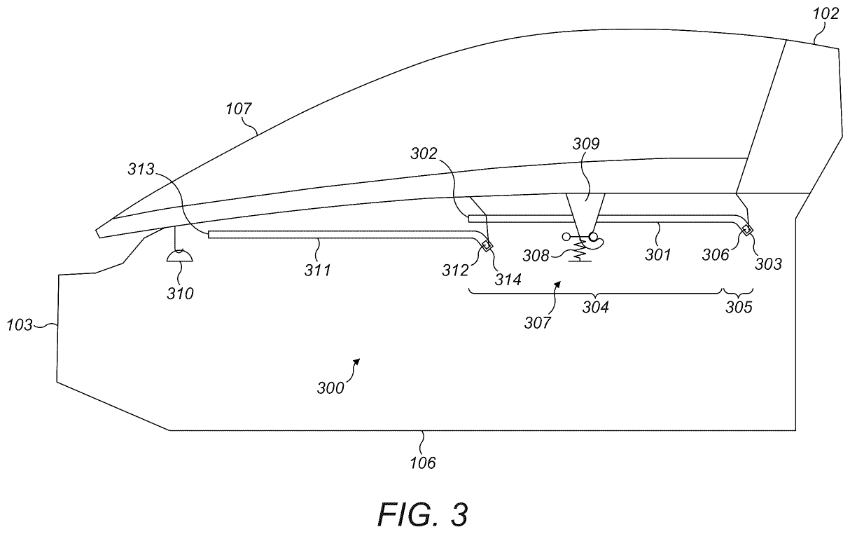

FIG. 3 illustrates a closer view of the vehicle cover 107 in the closed position. The vehicle 100 includes a mechanism 300 by which the vehicle cover can be actuated to move between the closed position and the open position. The actuating mechanism 300 includes a rail 301 affixed to the lower vehicle body 103. The rail 301 has a first end 302 and a second end 303. The first end 302 of the rail is closer to the vehicle body front 104 than the second end 303 of the rail. The rail 301 has a flat portion 304 and a sloped portion 305. The flat portion 304 extends generally along a longitudinal direction of the vehicle 100. The flat portion 304 of the rail 301 extends in a direction generally parallel to vehicle body floor 106. The frontmost end of the flat portion 304 of the rail is the first end 302 of the rail 301.

The flat portion 304 of the rail 301 is located forward of the sloped portion 305. In other words, the flat portion 304 is located closer to the vehicle body front 104 than the sloped portion 305. The sloped portion 305 is located closer to the vehicle body rear 105 than the flat portion 304.

The sloped portion 305 is inclined towards the vehicle body floor 106. The sloped portion extends downwards away from the flat portion. In the example seen in FIG. 3, the sloped portion 305 is at an angle of approximately 45 degrees with the flat portion 304 of the rail. According to other examples, the angle between the sloped portion and the flat portion may be 10, 15, 20, 25, 30, 35 or 40 degrees. According to other examples, the angle between the sloped portion and the flat portion may be 50, 55, 60, 65, 70 or 75 degrees. The sloped portion 305 may be curved. The sloped portion 305 may be straight and transverse to the flat portion 304. The rearmost end of the sloped portion 305 is the second end 303 of the rail 301.

In the example seen in FIG. 3, the length of the flat portion 304 is greater than the length of the sloped portion 305. The flat portion 304 is long enough such that the cover 107 can be actuated along the rail and moved far enough from the closed position that the cabin is accessible to a driver. In other words, so that that a driver can fit through an opening to enter the cabin. For example, the flat portion 304 has a length of 500 mm. According to other examples, the flat portion may have a length of 400 mm, 600 mm, 700 mm, 800 mm, 900 mm or 1000 mm. The sloped portion is long enough such that the vehicle cover 107 can be moved in and out of engagement with the vehicle body by moving along the sloped portion. The sloped portion may have a length of 50 mm. According to other examples, the sloped portion may have a length of 30 mm, 40 mm, 60 mm, 70 mm or 80 mm. The perpendicular distance between the first end 302 of the rail and the second end 303 of the rail may be 40 mm. According to other examples, the perpendicular distance between the first end 302 of the rail and the second end 303 of the rail may be 30 mm, 50 mm or 60 mm.

The vehicle cover 107 is configured to engage and slide between the first end and second end of the rail 301. FIG. 3 shows that the vehicle cover 107 comprises a runner 306. The runner 306 engages a groove in the rail 301 and may translate relative to the rail. The runner may comprise a strut or nylon block attached to a wheel. The wheel may engage a groove in the rail and rotates as it moves along the rail.

According to different example, instead of or in addition to the groove, the rail 301 may comprise a toothed portion. The wheel of the runner may be a toothed gear wheel configured to engage the toothed portion of the rail. According to this example, the teeth of the runner may movably engage the teeth of the rail to allow the toothed gear wheel to translate relative to the rail 301.

When the vehicle cover 107 is in the closed position, the runner 306 is positioned at the second end 303 of the rail 301. Thus, when the runner 306 is positioned at the second end of the rail, the vehicle cover 107 abuts the lower vehicle body 103 and the upper vehicle body 102 so as to form a closed cabin 201 within the vehicle.

When the vehicle cover is in the open position, the runner 306 is positioned at the first end 302 of the rail 301. In the open position, the cover 107 no longer abuts the upper vehicle body 102. The cover may also no longer abut the lower vehicle body 103.

As previously discussed, the sloped portion 305 of the rail 301 is inclined towards the vehicle body floor 106. The second end 303 is thus located closer to the vehicle body floor 106 than the first end 302. In other words, the second end is located at a lower position (at a lower elevation) than the first end.

When the vehicle cover is located in the open position, an external force is required to be imparted on the vehicle cover e.g. by an operator such as the driver, in order for the vehicle cover 107 to translate from the first end 302 along the rail 301 towards the second end 303. Since the second end 303 has a lower elevation than the first end and the sloped portion extends downwards away from the flat portion towards the second end, once a force has been imparted on the vehicle cover 107 that is sufficient for the vehicle cover to translate along the length of the flat portion 304, when the runner 306 reaches the sloped portion 305, the vehicle cover will automatically sink down towards the rail's second end 303 due to the effect of gravitational forces on the vehicle cover such that the vehicle cover is guided into the closed position.

Therefore in the opposite direction, i.e. when moving the vehicle cover 107 from the closed position (when the runner 306 is at the second end 303) to the open position (when the runner 306 is at the first end 302), an additional amount of force is required to move the vehicle cover 107 up the sloped portion and onto the flat portion.

To aid the operator in creating this additional amount of force, the vehicle body 101 comprises a lifting mechanism 307 that engages with the vehicle cover 107 when the runner 306 is at the second end 303 of the rail. The lifting mechanism 307 is configured to drive the runner 306 along the rail in a direction from the rail's second end towards its first end to permit the vehicle cover to move from the closed position towards the open position.

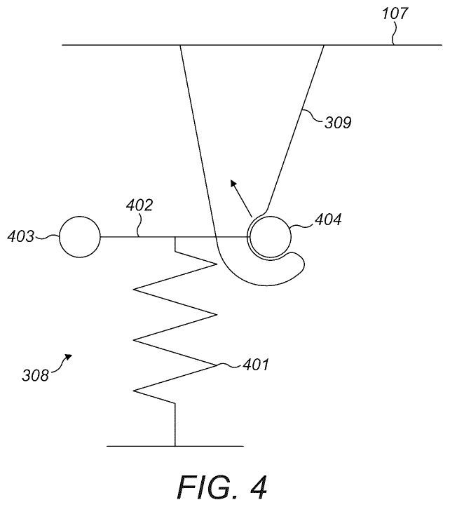

In the example seen in FIG. 3, the lifting mechanism comprises a spring-loaded catcher 308. The spring-loaded catcher 308 is seen in more detail in FIG. 4. The spring-loaded catcher comprises a compressible spring 401 attached at one end to the vehicle body and at the other end to an arm 402. The spring may be a coiled spring. The vehicle cover 107 includes a hook 309 which engages with the catcher when the vehicle cover 107 is in the closed position i.e. when the runner is at the second end 303 of the rail. When the vehicle cover 107 is in the closed position, the hook 309 engages the catcher and the spring is in a compressed configuration. The arm 402 of the catcher 308 comprises a pivot 403 at one end of the arm 402. In other words, the catcher is pivotally connected to the vehicle body. The arm 402 also comprises an engagement component 404. The engagement component 404 is located at the opposite end of the arm from the pivot 403. In FIGS. 3 and 4, the engagement component is engaged with the hook 309. The hook engages the catcher 308 via the engagement component 404. The vehicle 100 further includes a latch mechanism 310 between the vehicle cover 107 and the vehicle body 101. In the example seen in FIG. 3, the latch mechanism comprises a hook and claw which are releasably engaged with one another. In FIG. 3, the latch mechanism 310 is shown to be located towards the vehicle body front i.e. the front of the vehicle cover, however according to other examples, the latch mechanism may be positioned elsewhere on the vehicle body. According to some examples, the vehicle may comprise more than one latch mechanism between the vehicle cover and the vehicle body. As previously described, when the runner 306 of the vehicle cover is moving in a direction towards the closed position and the runner 306 reaches the sloped portion 305, the vehicle cover will automatically sink down towards the rail's second end 303. The spring of the spring-loaded catcher 308 is compressed as the vehicle cover sinks down the sloped portion of the rail. When the vehicle cover's runner 306 reaches the rail's second end 303, the hook 309 engages the catcher and the latch mechanism 310 is engaged such that when the vehicle cover 107 is in the closed position, the latch mechanism 310 fastens the vehicle body 101 to the vehicle cover 107. In other words, the hook and claw of the latch mechanism 310 engage one another when the vehicle cover is in the closed position. The latch mechanism, when engaged, is configured to keep the vehicle cover in a position such that it abuts the upper vehicle body 102 and the lower vehicle body 103. When the latch mechanism is engaged, the hook 309 remains engaged with the catcher of the spring-loaded catcher 308.

The latch mechanism 310 is releasable, for example by actuation of a switch or lever on the exterior of the vehicle body 110 or within the vehicle cabin 201. When the latch mechanism 310 is released, the hook disengages from the claw. When the latch is released by actuation of the switch/lever, the lifting mechanism 307 is activated. Specifically, release of the latch mechanism 310 means that the catcher is free to disengage from the hook. When the latch mechanism is released, the spring expands causing the catcher to disengage from the hook. According to the example seen in FIGS. 3 and 4, the arm 402 is attached to the vehicle body at pivot 403 such that when the latch mechanism is released, expansion of the spring 401 causes a rotation of the arm 402 about the pivot, thereby disengaging from the hook 309. In other words, when the latch is released and spring 401 expands, the spring 401 exerts on a force on the arm 402 and thereby engagement component 404 such that the engagement component disengages from the hook 309. Furthermore, due to the upward motion exerted by the spring on the arm 402, the engagement component 404, imparts a force on a contacting surface of the hook 309 as it disengages from the hook. The force exerted by the engagement component 404 on the hook 309 is illustrated by an arrow in FIG. 4. In this example, the direction of the force exerted on the hook is upwards at an angle of approximately 45 degrees with respect to the flat portion of the rail 304. The spring therefore exerts a force on the hook 309 in a direction substantially parallel to the sloped portion of the rail 305. As mentioned, the hook 309 is attached to the vehicle cover 107 such that the spring exerts a force on the vehicle cover 107 in a direction parallel to the sloped portion of the rail 305. Therefore, due to the upward force imparted on the vehicle cover by the expansion of the spring, the runner 306 is urged upwards along the sloped portion of the rail in a direction away from the second 303 i.e. towards the open position.

The potential energy stored in the spring from its earlier compression is transferred into kinetic energy of the runner as it expands and provides enough of a force to cause the vehicle cover to travel along the length of the sloped portion 305 and onto the flat portion 304 of the rail. As described with respect to motion of the vehicle cover towards the closed position, when the runner reaches the flat portion of the rail, an external force is required to be imparted on the vehicle cover e.g. by an operator, in order for the vehicle cover 107 to translate along the flat portion in a direction towards the first end i.e. to fully open the cabin 201. However, as previously described, since the flat portion extends generally along a longitudinal direction of the vehicle (i.e. without any significant change in elevation), the operator is not required to impart much force to move the vehicle cover into the open position.

According to other examples, the lifting mechanism may comprise a different mechanism. The type of lifting mechanism used may be selected based on the mass of the object being raised, i.e. the mass of the vehicle cover. The lifting mechanism may comprise a gas strut or a weighted lever. In the example seen in FIGS. 3 and 4, the arm 402 is biased by means of a spring 401, However according to other examples, the arm 402 may be biased by means of a gas strut or weighted lever. According to a further example, the lifting mechanism may comprise a compressible rubber element on which the vehicle cover may rest. According to this example, when the vehicle cover is in the closed position, the cover compresses the rubber element. In order to aid the vehicle cover in moving from the closed position towards the open position, when the latch mechanism is released, the rubber element expands providing some upward force to drive the vehicle cover from the closed position towards the open position.

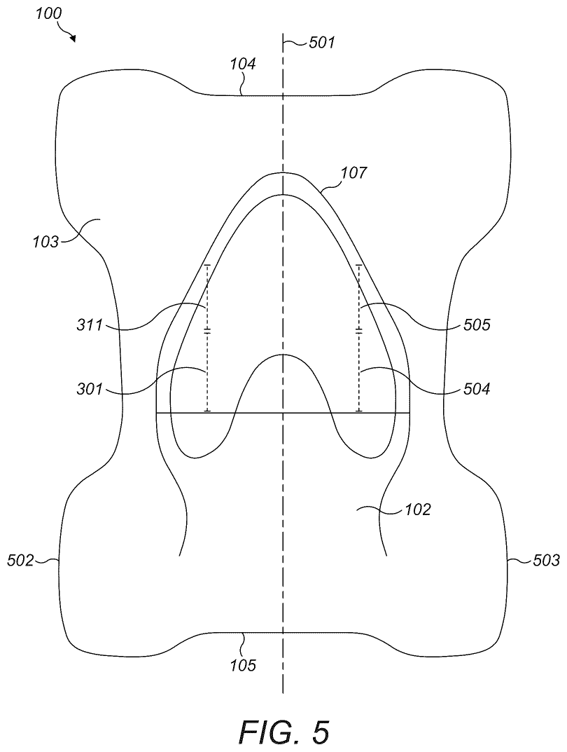

The preceding passage has described a single rail 301 along which the vehicle cover 107 may be translated between an open and closed position. The vehicle 100 may comprise an equivalent rail on the opposite side of the vehicle. FIG. 5 illustrates a bird's eye view of the vehicle 100 having the vehicle cover 107 in a closed position. FIG. 5 illustrates a longitudinal centre line 501 (indicated by a dashed line) which bisects the vehicle in the vehicle's longitudinal direction. The longitudinal centre line 501 divides the vehicle and the vehicle cover 107 into a left side 502 (seen in FIGS. 1 to 3) and a right side 503.

The vehicle 100 includes on the right side 503, a rail 504 affixed to the lower vehicle body 103. Since rails located on vehicle 100 are located below the vehicle cover 107 and would therefore not be visible when viewing the vehicle from above, the positions of rails have been illustrated in FIG. 5 using dotted lines. The positions of rail 504 and rail 301 are symmetrical about the longitudinal centre line 501. The rail 504 has the same shape as rail 301 previously described. The vehicle cover 107 is configured to engage and slide along the rails 301 and 504. The vehicle cover 107 comprises a further runner located on the right side of the vehicle. The further runner engages a groove in the rail 504 and may translate relative to the rail. Movement of the vehicle cover 107 by means of the further runner engaging with rail 504 is as described previously with respect to runner 306 and rail 301.

The right side of the vehicle 503 may also comprise a lifting mechanism including a spring-loaded catcher and hook which functions as previously described to drive the vehicle roof towards the open position. The vehicle may further comprise a latch mechanism on its right side which functions in the same way as described with respect to latch mechanism 310 and spring-loaded catcher 308. Alternatively, the vehicle may comprise only a single latch mechanism, which when released allows the spring-loaded catchers on both sides of the vehicle to disengage from their respective hooks and drive both runners along rails 301 and 504. In other words, the vehicle 100 may comprise two identical or similar mechanisms, one located on either side of the centre line 501, for allowing the vehicle cover 107 to move between the open and closed positions on rails 301 and 504.

Furthermore, according to some examples, such as that seen in FIGS. 3 and 4, the vehicle may comprise more than one rail on a single side of the vehicle. In other words, the vehicle may comprise more than one rail on the left side 502 of centre line 501 and more than one rail on the right side 403 of the centre line 501. For example, FIG. 5 shows that vehicle 100 has two rails 301 and 311 on the left side 502 of plane 501. The vehicle has two rails 504 and 505 on the right side 503 of the longitudinal centre line 501.

As previously mentioned, FIG. 3 shows the left side of the vehicle 100 and shows two rails 301 and 311. In other words, the vehicle 100 includes a further rail 311 affixed to the lower vehicle body 103. The additional rail 311 is located forward of the rail 301. Rail 311 is located substantially between the rail 301 and the vehicle body front 104. In other words, rail 301 is located substantially between rail 311 and the vehicle body rear 105. As seen in FIG. 3, rail 311 may be located at a lower position than rail 301. In other words, the rail 311 may be located closer to the vehicle body floor 106 than the rail 301. According to other examples, rail 301 may be located at a lower position than rail 301. As shown in FIG. 3, the additional rail 311 may overlap the rail 301 in a vertical direction.

The vehicle cover 107 is configured to engage and slide along rails 301 and 311. FIG. 3 shows that the vehicle cover 107 comprises a further runner 312. The runner 312 engages a groove in the rail 311 and may translate relative to the rail. The runner may comprise a wheel which rotates as it moves along the rail. The runner 312 may have the same form as runner 306.

In the example seen in FIG. 3, the shape of the rail 311 is similar to that of rail 301. According to other examples, depending on the relative positions of rails 301 and 311 and the location of the runners 306 and 312, the rail 311 may have a shape that is the same as that of rail 301. According to further examples, rails 301 and 311 may have different shapes. For example, as is the case for rail 301, the rail 311 may comprise a flat portion and a sloped portion, however the flat and sloped portions of rail 311 may be different lengths to the flat and sloped portions of rail 301. The rail 311 has a first end 313 and a second end 314.

Motion of the runner 312 along rail 311 may be the same as previously described with respect to runner 306 and rail 301. According to the example seen in FIG. 3, the left side of the vehicle includes the lifting mechanism 307 which is used to aid both runners 312 and 303 in translating from the second ends 314, 303 towards the first ends 302, 313 of their respective rails, 311, 301. Thus the lifting mechanism 307 engages with the vehicle cover 107 via hook 309 when the runner 306 is at the second end 303 of the rail 301 and when the runner 302 is at the second end 314 of the rail 311. The lifting mechanism 307 is configured to drive the runners 306, 312 along the rails to permit the vehicle cover to move from the closed position towards the open position.

When the vehicle cover 107 is moving in a direction towards the closed position, when runners 306 and 312 reach the end of the flat portions of their respective rails 301, 311, they will sink down towards the respective second ends 303, 313, the spring of the spring-loaded catcher 308 will be compressed, the hook 309 will engage the arm 402 and the latch mechanism 310 will be engaged to fasten the vehicle body 101 to the vehicle cover 107.

The latch mechanism will interact with the lifting mechanism and motion of the runners in the same way as previously described with respect to a single rail/runner. As previously described, when the latch is released by actuation of a switch/lever, the engagement component 404 of arm 402 will disengage from the hook 309 and the spring 401 will expand. Due to the upward force imparted on the vehicle cover 107 by the expansion of the spring, both runners 306, 312 will be urged upwards along the sloped portion of their respective rails 301, 311 in a direction towards the open position.

FIG. 3 illustrates the left side 402 of vehicle 100. It will be appreciated that the actuating mechanism 300 on the vehicle's left side which allows the vehicle cover 107 to move between the open and closed position may be replicated on the vehicle's right side. In other words, the right side of the vehicle may include a lifting mechanism and a latch mechanism which operate to allow runners to slide along rails 504 and 505. The actuating mechanism on the right side of the vehicle may be a mirror image (reflected in centre line 501) of the actuating mechanism on the vehicle's left side. According to a different example, a single lifting mechanism, for example 307 located on the vehicle's left side may be used to urge the vehicle cover along all four rails 301, 311, 504, 505 in a direction towards the vehicle cover's open position.

According to further examples, a single latch mechanism may be used to hold the vehicle cover in the closed position. The latch mechanism may be positioned centrally on the vehicle, for example on or close to the longitudinal centre line 501.

The examples described herein refer to a vehicle which is illustrated as a road vehicle comprising four wheels. However, the retractable vehicle cover and mechanism for actuating its movement described herein may be applied equally to other types of vehicle, for example road vehicles with a different number of wheels, aircraft or watercraft vehicles.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A vehicle having a vehicle floor, a vehicle body and a vehicle cover configured to move between an open position and a closed position,
the vehicle body comprising:
a rail having a first end and a second end, the rail comprising:
a flat portion extending along a longitudinal direction of the vehicle at the first end; and
a sloped portion inclined towards the vehicle floor at the second end;
and the vehicle cover comprising:
a runner moveable along the rail to permit the vehicle cover to move between the closed position and the open position,
wherein the vehicle body further comprises a lifting mechanism that engages with the vehicle cover when the runner is at the second end of the rail, the lifting mechanism being configured to use stored elastic potential energy to drive the runner along the rail in a direction from the second end towards the first end to permit the vehicle cover to move from the closed position towards the open position,
wherein the stored elastic potential energy provides enough force to cause the vehicle cover to travel along the length of the sloped portion and onto the flat portion of the rail.

2. A vehicle according to claim 1, wherein the vehicle comprises a latch mechanism arranged between the vehicle body and the vehicle cover and the lifting mechanism is configured to drive the runner along the rail to move from the closed position towards the open position in response to the latch mechanism being released.

3. A vehicle according to claim 1, wherein the vehicle cover comprises a hook configured to engage with the lifting mechanism when the runner is at the second end of the rail.

4. A vehicle according to claim 1, wherein the lifting mechanism comprises an arm biased by means of one or more of a spring, a gas strut and a weighted lever.

5. A vehicle according to claim 3, wherein the lifting mechanism comprises an arm biased by means of one or more of a spring, a gas strut and a weighted lever and the arm is configured to engage the hook when the runner is at the second end of the rail.

6. A vehicle according to claim 1, wherein the vehicle body and vehicle cover are arranged such that an external force is required to move the runner along the straight portion of the rail in a direction towards the closed position.

7. A vehicle according claim 1, the vehicle being configured such that when the runner is moving along the straight portion of the rail in a direction towards the closed position and engages the sloped portion of the rail, the runner is configured to sink towards the second end of the rail.

8. A vehicle according to claim 1, wherein the vehicle body has a vehicle body front and a vehicle body rear and motion of the vehicle cover from the closed position towards the open position is towards the vehicle front.

9. A vehicle according to claim 1, wherein the vehicle body comprises:
a second rail, the second rail having a first end and a second end, the second rail comprising:
a flat portion extending along a longitudinal direction of the vehicle at the first end; and
a sloped portion inclined towards the vehicle floor at the second end;
and the vehicle cover comprises a second runner moveable along the second rail.

10. A vehicle according to claim 9, wherein the shape of the second rail is the same as the shape of the first rail.

11. A vehicle according to claim 9, wherein the vehicle body comprises a second lifting mechanism that engages with the vehicle cover when the second runner is at the second end of the rail, the second lifting mechanism being configured to drive the second runner along the second rail in a direction from the second end of the second rail towards the first end of the second rail.

12. A vehicle according to claim 11, wherein the vehicle cover comprises a second hook configured to engage with the second lifting mechanism when the second runner is at the second end of the second rail.

13. A vehicle according to claim 9, wherein the vehicle body has a vehicle body front and a vehicle body rear and a longitudinal centre line extending between the vehicle body front and the vehicle body rear and intersecting the vehicle cover, wherein the rail is located on a first side of the longitudinal centre line and the second rail is located on a second side of the longitudinal centre line.

14. A vehicle according to claim 13, wherein the vehicle body comprises a third rail located on the first side of the longitudinal centre line and a fourth rail located on the second side of the longitudinal centre line.

15. A vehicle according to claim 14, wherein the third rail and the fourth rail each have a first end and a second end and comprise:
a flat portion extending along a longitudinal direction of the vehicle at the first end; and
a sloped portion inclined towards the floor of the vehicle at the second end.

16. A vehicle according to claim 15, wherein the first end of the third rail is located between the first rail and the vehicle body front and the first end of the fourth rail is located between the second rail and the vehicle body front.

17. A vehicle according to claim 14, wherein the vehicle cover comprises a third runner moveable along the third rail on the vehicle body and a fourth runner moveable along the fourth rail on the vehicle body.

18. A vehicle according to claim 17, wherein the lifting mechanism is further configured to drive the third runner along the third rail in a direction from the second end of the third rail towards the first end of the third rail and the second lifting mechanism is further configured to drive the fourth runner along the fourth rail in a direction from the second end of the fourth rail towards the first end of the fourth rail.

19. A vehicle according to claim 1, wherein the sloped portion is curved.

20. A vehicle according to claim 1, wherein the sloped portion is straight and transverse to the flat portion.

20.-22. (canceled)
